(19) United States
(12) Patent Application Publication
(10) Pub. No.: US 2008/0199316 A1
(43) Pub. Date: Aug. 21, 2008

(54) ROTOR BLADE STRUCTURE FOR A PNEUMATIC DEVICE

(76) Inventor: Tse-Hua Chang, Cingshuei Township (TW)

Correspondence Address: EGBERT LAW OFFICES, 412 MAIN STREET, 7TH FLOOR, HOUSTON, TX, 77002, US

(21) Appl. No.: 11/676,351

(22) Filed: Feb. 19, 2007

(51) Int. Cl. F03B 3/12

(52) U.S. Cl. 416/92

(57) ABSTRACT

The rotor blade structure for the pneumatic devices includes a blade mounted into the preset chamber of a drive rotor of a pneumatic device. The blade with predefined edge and thickness has an assembly side, an external side and two windshield surfaces. At least one windshield surface is provided with a recessed portion. There may be a single recessed portion or a plurality of recessed portions. Hence, the recessed portion could increase the compression area of blade's windshield surface, thus improving the driving force of the blade and torsion of drive rotor with higher practicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to the components of pneumatic devices, and more particularly to an innovative rotor blade structure.

2. Description of Related Art Including Information Disclosed Under 37 CFR 1.97 and 37 CFR 1.98.

Pneumatic devices (e.g. pneumatic grinding machines, pneumatic handles and screwdrivers) are mainly operated with a drive rotor in the cylinder, which generates rotary motion under the pneumatic actuation of mobile blades arranged at intervals. Then, the tools of the pneumatic devices (e.g. grinding disks and screwdriver bars) are driven simultaneously for rotary motion.

Since the rotation of the drive rotor depends upon pneumatic pressure for the blades, the structural design of rotor blade is one of the key factors to the rotary torsion of a drive rotor.

As for existing pneumatic devices, the blade structure of a drive rotor is typically a plate with a flat plane at both sides. Such blade structure has not been modified significantly apart from a little change in profile shape. However, the pneumatically-driven blade of the drive rotor could be improved in order to promote the rotary torsion of the drive rotor. Given the two flat planes at both sides of the conventional blade, i.e. the windward side is a flat plane, the compression area is equal to the area of the plane, so the pneumatic driving force is not improved. Moreover, it leads to insufficient torsion of the drive rotor, since air pressure may be laterally lost along the flat surface of blade.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The enhanced efficacy of the present invention is as follows:

1. With the addition of recessed portion 14, the present invention allows increase of the compression area of windshield surface 13 of the blade 10, thus improving the driving force of blade 10 and the torsion of drive rotor 30.

2. When the windshield surface 13 of the blade 10 is driven by air pressure, the recessed portion 14 may gather and accommodate air, thus reducing greatly the lateral air loss and improving significantly the torsion of drive rotor 30.

The improvements brought about by this invention are based on the structure. Assembly side 11 of said blade 10 is additionally provided with sloped edges 17 and a recessed portion 18. Air flows smoothly from the sloped edge 17 into the space of recessed portion 18. In such a case, the external side 12 of the blade 10 could be mated tightly with an inner wall of the air-chamber enclosure of the pneumatic device, thereby improving air-tightness and torsion of drive rotor 30.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a cross-sectional view of installation of the drive rotor and blade in the pneumatic device.

FIG. 2 shows an exploded perspective view of local components of the pneumatic device of the present invention.

FIG. 3 shows a perspective view of blade structure of the preferred embodiment of the present invention.

FIG. 4 shows another perspective view of the recessed portion of the blade of the present invention.

FIG. 5 shows a sectional view of the recessed portion of the blade of the preferred embodiment of the present invention.

FIG. 6 shows another sectional view of the recessed portion of the blade of the preferred embodiment of the present invention.

FIG.7 shows another sectional view of the recessed portion of the blade of the preferred embodiment of the present invention.

FIG. 8 shows a sectional view of installation of the drive rotor and blade into the air-chamber enclosure of the pneumatic device.

FIG. 9 shows a sectional view of operation of the recessed portion of the blade of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

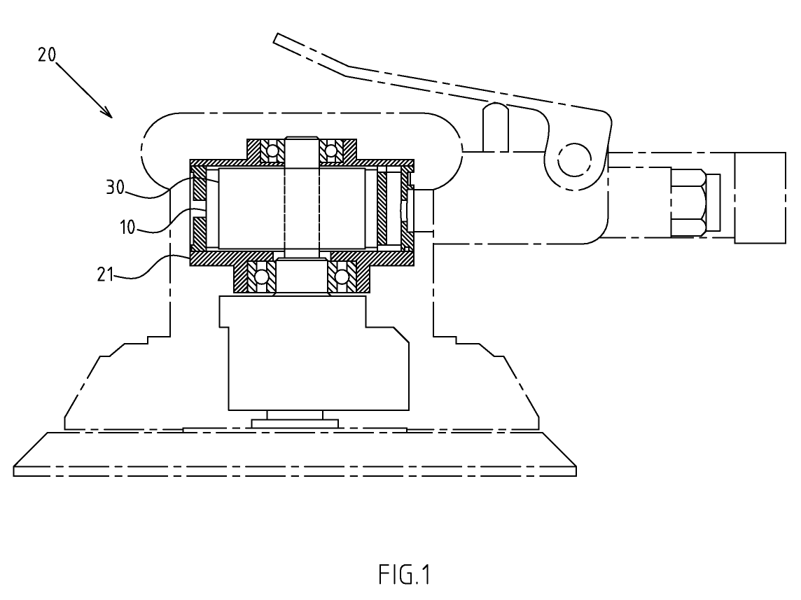

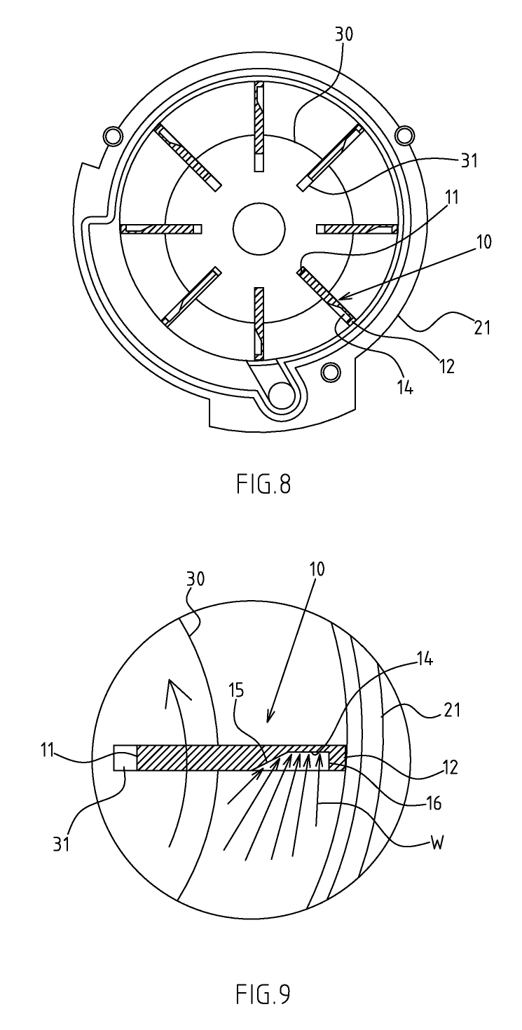

FIGS. 1, 2 and 3 depict preferred embodiments of improved rotor blade structure of the drive rotor of the pneumatic device in the present invention. These embodiments are provided only for explanatory purposes. The scope of the invention is set by the claims. The blade 10 is mounted into the chamber 31 of drive rotor 30 of existing pneumatic device 20. The pneumatic device 20 of the preferred embodiment is a pneumatic grinding machine. The drive rotor 30 is eccentrically placed into an air-chamber enclosure 21 of the pneumatic device 20 for a rotary state (shown in FIG. 8), while the blades 10 may rotate synchronously with the drive rotor 30, and could be adjusted flexibly depending on the variable distance with air-chamber enclosure 21. The blade 10 with predefined edge and thickness has an assembly side 11, an external side 12 and two windshield surfaces 13.

The major feature of the present invention is that at least one windshield surface 13 of said blade 10 is provided with a recessed portion 14.

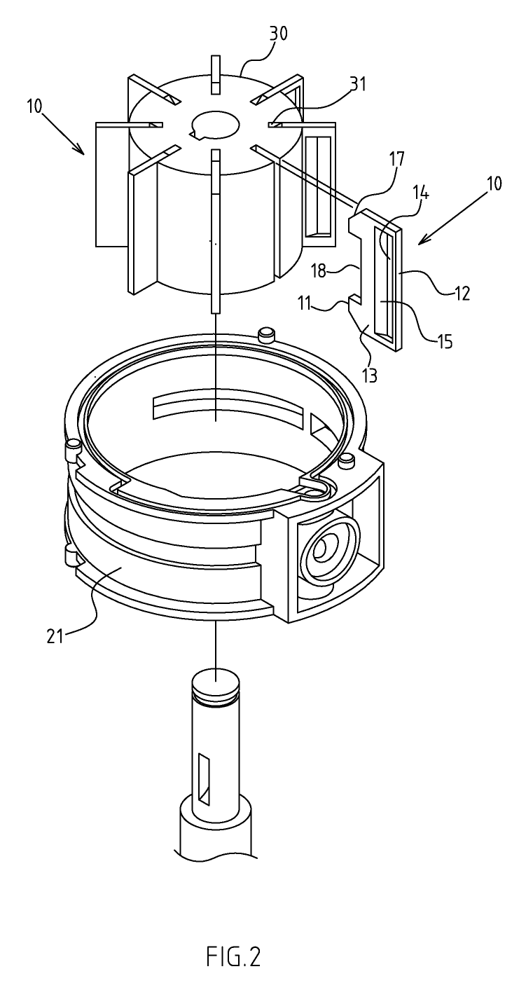

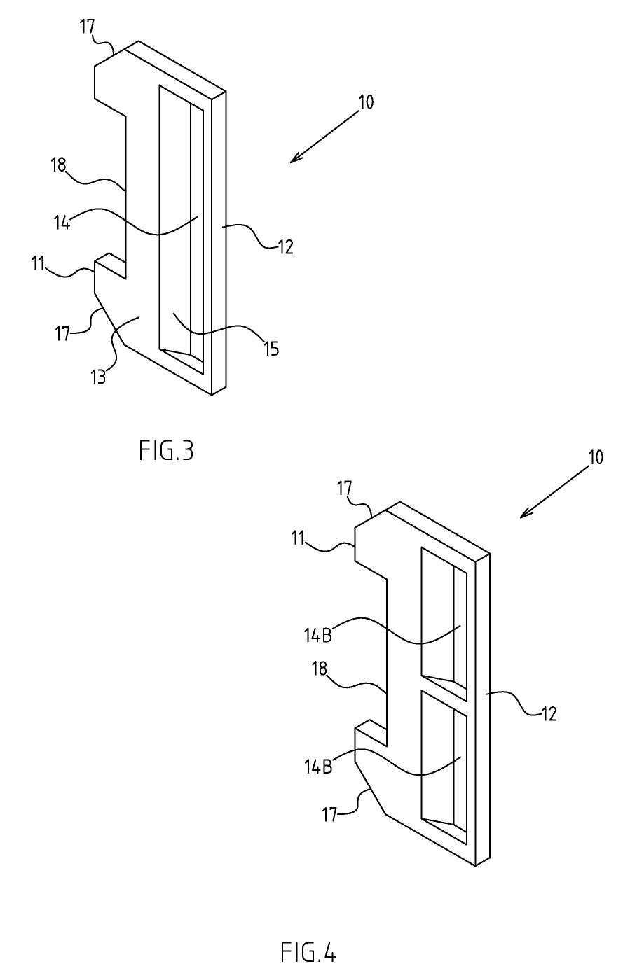

Referring to FIGS. 2, 3, there may be a single recessed portion 14, or a plurality of recessed portions 14B as shown in FIG. 4.

Referring to FIGS. 3, 5, the recessed portion 14 is provided with an oblique guide edge 15 nearby the assembly side 11 of blade 10, while a side wall 16 of recessed portion 14 is arranged vertically far away from the oblique guide edge 15 (in relation to the windshield surface 13).

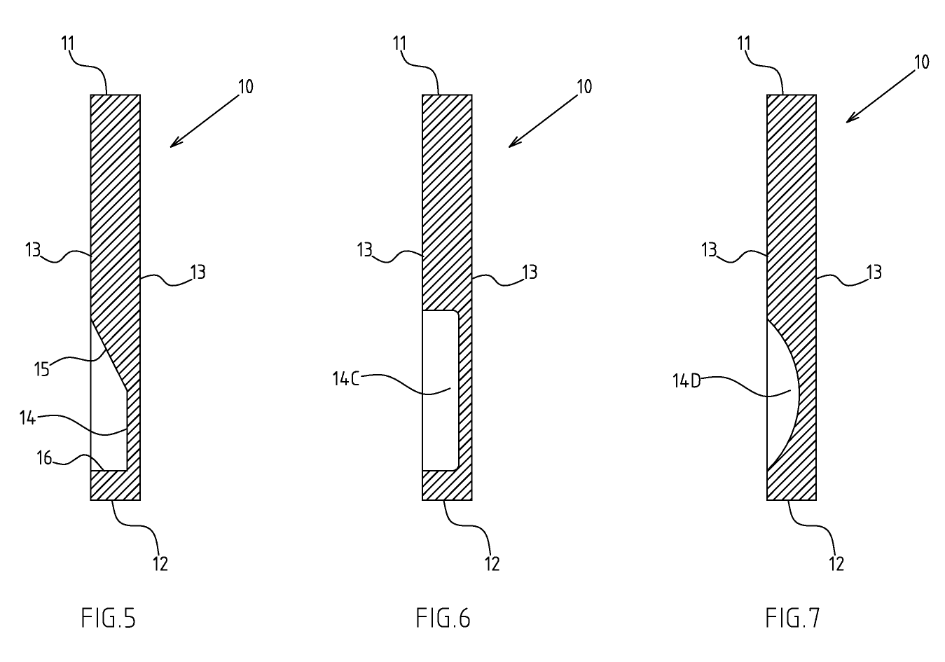

Said recessed portion is available with a variety of cross sections. For example, the recessed portion 14C in FIG. 6 has a L-shaped cross section. The recessed portion 14D in FIG. 7 has a cavetto cross section, as well as V-shaped and trapezoidal cross sections.

Referring to FIG. 3, the assembly side 11 of said blade 10 is provided with two sloped edges 17 at two corners and a recessed portion 18 at central section. The sloped edges 17 and recessed portion 18 are mainly designed to guide air into the position between assembly side 11 of blade 10 and the chamber 31 of drive rotor 30, thereby helping protrusion of the blade 10. With sloped edges 17 and recessed portion 18 of assembly side 11, air could flow smoothly from the sloped edge 17 into the space of recessed portion 18. In such case, the external side 12 of the blade 10 could be mated tightly with inner wall of air-chamber enclosure of the pneumatic device, thereby improving air-tightness and torsion of drive rotor 30 and reducing greatly air leakage.

Referring to FIG. 8, when air is guided into air-chamber enclosure 21 of the pneumatic device 20 to drive the blade 10, the drive rotor 30 could generate rotary motion in a similar operating principle. With said recessed portion 14, the present invention allows increase of the compression area of windshield surface 13 of the blade 10 (note: the curved area of the recessed portion 14 is bigger than the plane area of typical blade), thus improving the driving force of blade 10 and the torsion of drive rotor 30. Referring also to FIG. 9, when windshield surface 13 of the blade 10 is driven by air pressure W, the recessed portion 14 may gather and accommodate air, thus reducing greatly the lateral air loss.

1. A rotor blade structure for a pneumatic device, said pneumatic device having a drive rotor with a preset chamber, said rotor blade structure comprising:
a blade with predefined edge and thickness, being mounted in said preset chamber, said blade being comprised of an assembly side, an external side and two windshield surfaces;
wherein at least one windshield surface has a recessed portion.

2. The rotor blade structure defined in claim 1, wherein said recessed portion is comprised of a plurality of recessed portions.

3. The rotor blade structure defined in claim 1, wherein said recessed portion is provided with an oblique guide edge nearby said assembly side.

4. The rotor blade structure defined in claim 1, wherein said recessed portion has a [symbol] -shaped, V-shaped, cavetto or trapezoidal cross sections.

5. The rotor blade structure defined in claim 1, wherein the said assembly side of said blade is provided with two sloped edges at two corners and a recessed portion at a central section thereof.
